(19) United States
(12) Patent Application Publication
(10) Pub. No.: US 2019/0176121 A1
(43) Pub. Date: Jun. 13, 2019

(54) MAGNETIC NANOCAPSULES AS THERMOLATENT POLYMERIZATION CATALYSTS OR INITIATORS

(71) Applicants: HENKEL AG & CO. KGAA, Duesseldorf (DE); MAX-PLANCK-GESELLSCHAFT ZUR FÖRDERUNG DER WISSENSCHAFTEN E.V., Muenchen (DE)

(72) Inventors: Andreas Taden, Duesseldorf (DE); Ann-Christin Bijlard, Duesseldorf (DE); Anne Hansen, Nettersheim (DE); Horst Beck, Neuss (DE); Katharina Landfester, Mainz (DE)

(21) Appl. No.: 16/277,348

(22) Filed: Feb. 15, 2019

Related U.S. Application Data
(63) Continuation of application No. PCT/EP2017/070695, filed on Aug. 16, 2017.

(30) Foreign Application Priority Data
Aug. 16, 2016 (EP) 16184291.9

(51) Int. Cl. B01J 13/18; C08F 220/14; C08K 3/22; C09J 175/04; C09J 11/08; C09J 11/04; C09K 3/10

(52) U.S. Cl. CPC B01J 13/185; H01F 1/0306; C08K 3/22; C09J 175/04; C09J 11/08; C09J 11/04; C09K 3/1021; C08F 2810/20; C08F 2800/20; C08K 2003/2275; C08K 2201/011; C08K 2201/01; C09K 2200/0625; C09K 2200/0239; C08F 220/14

(57) ABSTRACT

The present invention relates to a process for producing nanocapsules employable as thermo latent polymerization catalysts, in particular for the polymerization of polyurethanes, by means of a high shear process, wherein the process comprises: (i) emulsifying a first reaction mixture (a) in a continuous aqueous phase comprising at least one stabilizer; (ii) emulsifying a second reaction mixture (b) in a continuous aqueous phase comprising at least one stabilizer; (iii) combining the first reaction to the nanocapsules produced by means of the described processes, to the use thereof, and to agents which contain these nanocapsules.

### FIELD OF THE INVENTION

The present invention relates to a process for the preparation of special nanocapsules which can be used as thermolatent polymerization catalysts/initiators, in particular for the polymerization of polyurethanes. The invention further relates to nanocapsules prepared by the described processes, their use and agents containing these nanocapsules.

### BACKGROUND OF THE INVENTION

Polyurethanes are widely used materials that find application in a variety of fields. However, especially for systems based on aliphatic isocyanates catalysts are often required in order to accelerate the polymerization reaction of polyurethanes and to lower the cure temperatures. Predominantly, for this purpose, organotin compounds are used, wherein dibutyltin dilaurate (DBTL) is the most widely used catalyst. However, due to growing concerns about the toxicity of DBTL other tin-based catalysts, such as tin dodecanoate, are used. However, a complete abandonment of tin-based catalyst systems would be particularly desirable from both ecological and health aspects.

In general, the catalysts used are highly reactive, which drastically shortens the pot life of PU materials. To overcome this disadvantage, a number of approaches are known, such as the use of blocked isocyanates or UV-curable systems. However, these in turn suffer from the fact that high temperatures are required for activation or that the application areas are limited to those in which a UV activation is practicable. Another alternative is provided by thermolatent catalysts, i.e. delayed-action catalysts that are heat-activated. Tin (II) and tin (IV) alkoxy catalysts have been proposed for this purpose (Zoller et al. 2013) Inorganic Chem. 52(4): 1872-82). However, these require complex synthesis methods. Another alternative is provided by systems based on a physical barrier, where microcapsules are already well established in the art. Microcapsules have a size of 1 to 1,000 μm and are usually opened mechanically by breaking, whereby the content is released. A disadvantage of microcapsules, however, is that they tend to coagulation or sedimentation during use, and their use is limited to applications in which the size of the capsules does not have adverse effects, such as in infusion processes in the composite area, where the fibers used as a reinforcement may prevent the complete penetration of a laid fabric with a microcapsule-containing polymer resin by retaining the microcapsules.

Nanocapsules represent an alternative to the known microcapsules. However, due to their size in the range of only 50 to 500 nm (z-average from dynamic light scattering (DLS)), these capsules can not be opened mechanically by rupture, but must be formulated to open as a reaction to certain signals or ambient conditions. However, it is difficult to achieve a high encapsulation efficiency with nanocapsules, which is due to the small size and the fact that the thin shell of the nanocapsules may only have a limited use as a diffusion barrier, without special precautions or adjustments.

### BRIEF SUMMARY OF THE INVENTION

The object of the present invention was therefore to provide nanocapsules which overcome the existing disadvantages and are suitable as thermolatent catalysts.

The present invention solves this problem by producing the nanocapsules in one step by means of a combined emulsion/mini-emulsion polymerization approach from a monomer mixture and encapsulated magnetic nanoparticles and optionally a hydrophobic release agent. Depending on the conditions of preparation, the nanocapsules obtainable in this way have different morphologies, wherein the polymer formed from the monomers forms a shell or a matrix, and the magnetic nanoparticles and optionally the release agent form the core or are embedded in the polymer matrix. The magnetic nanoparticles are able to catalyze the polyaddition reaction of compounds with isocyanate groups and NCO-reactive groups to form polyurethanes. For this reason, the use of customary catalyst/initiator substances, in particular tin-based catalyst/initiator substances, can be completely dispensed with.

The nanocapsules thus obtainable are thermolatent, i.e. the content of the nanocapsules can be released in a controlled way by increasing the temperature. However, the release can also take place via alternative mechanisms. In the first case, the substances contained in the core of the nanocapsules are themselves sufficiently compatible with the capsule shell at elevated temperature to overcome the barrier of the nanocapsule sheath (but at the temperatures used in the encapsulation and storage, they are sufficiently incompatible for allowing an encapsulation and prevent a premature release). In the second case, the magnetic nanoparticles contained in the nanocapsules according to the invention are heated by applying an external magnetic field according to the induction principle. By such heating of the nanocapsules above the glass transition temperature of the polymer shell, it becomes permeable or breaks up and the content of the nanocapsules, which is localized in the core or in the polymer matrix, is released in a targeted manner. Consequently, even in this case, the nanocapsules are sufficiently stable at temperatures prevailing during encapsulation and storage, thereby preventing premature release. In the third case, a release agent is used, which swells at elevated temperature the capsule shell and thus makes it permeable to the contents of the capsule. On the other hand, the elevated temperature release agent is sufficiently compatible with the capsule shell to have a softening effect, but sufficiently incompatible at the temperatures used in manufacture and storage to allow for efficient encapsulation. In a fourth case, a propellant is used as the releasing agent, wherein the propellant is chosen such that it vaporizes at a fixed temperature and, due to the increasing pressure inside the nanocapsules, breaks them up, thereby liberating the catalyst.

The nanocapsules are also characterized by a very high encapsulation efficiency and a high colloidal stability and prevent the release of the capsule contents under standard conditions very effectively, so that thus formulated PU materials have extended pot life.

### BRIEF DESCRIPTION OF THE DRAWINGS

FIG. 1 shows the morphology of the magnetic nanocapsules containing 10 wt.-% Magnetite prepared via a mini-emulsion in step (ii) of the process as described herein at various resolutions.

FIG. 2 shows the morphology of magnetic nanocapsules containing the catalyst Fomrez with 15 wt.-% and 46 wt.-% magnetite (FIG. 2a), 2b), 2c)) or 64% wt.-%, respectively, of magnetite (FIG. 2d), 2e), 2f)).

FIG. 3 shows the morphology of the magnetic nanocapsules containing 58 wt.-% Magnetite (LMOA) at different resolutions.

FIG. 4 shows the time-dependent measurement of complex viscosity matrix-forming monomers at a) 50° C. and b) 120° C. of nanocapsules without magnetic nanoparticles (FIG. 4c); TLCN 1), magnetic nanocapsules containing 54 wt.-% of magnetite and the catalyst Fomrez (FIG. 4d), LMOA F), and magnetic nanocapsules containing 64 wt.-% of magnetite and the catalyst Fomrez (FIG. 4e), HMOA F).

FIG. 5 shows a VSM measurement of magnetic nanoparticles containing 58 wt.-% of magnetite (LMOA).

FIG. 6 shows the time-dependent measurement of the complex viscosity of matrix-forming monomers at 50° C. and 120° C. of a) the pure matrix (castor oil and IPDI trimer), b) the matrix and magnetite with oleic acid functionalization, c) the matrix and magnetite without oleic acid functionalization, d) the matrix and oleic acid, e) the matrix and LMOA.

### DETAILED DESCRIPTION OF THE INVENTION

In a first aspect, therefore, the invention relates to a process for the preparation of nanocapsules containing magnetic nanoparticles, characterized in that the process comprises:

(A)

(i) Emulsifying a first reaction mixture (a) into a continuous aqueous phase, in particular water, which comprises at least one stabilizer, in particular at least one surfactant, to produce a first emulsion, wherein the first reaction mixture, based on the total weight of the reaction mixture, comprises 10.0 to 99.0 wt.-% of a monomer mixture, wherein the monomer mixture, based on the total weight of monomer mixture, comprises:

(a1) 2.5 to 19.0 wt.-%, in particular 5.0 to 12.0 wt.-%, of at least one monoethylenically unsaturated C₃₋₅-carboxylic acid monomer;

(a2) 76.0 to 97.5 wt.-%, in particular 85.0 to 95.0 wt.-%, of at least one monoethylenically unsaturated C₃₋₅-carboxylic acid C₁₋₁₀-alkyl ester monomer; and (a3) 0.0 to 5.0 wt.-%, in particular 0.0 to 3.0 wt.-%, of at least one monomer which carries at least two ethylenically unsaturated groups, preferably one divinylbenzene or a di- or triester of a C₂-C₁₀ polyol with ethylenically unsaturated C₃-C₅ carboxylic acids, in particular a di- or triester of a C₂-C₁₀ alkane diol or triol with ethylenically unsaturated C₃-C₅ carboxylic acids;

(ii) Emulsifying a second reaction mixture (b) into a continuous aqueous phase, in particular water, which optionally comprises at least one stabilizer, in particular at least one surfactant, to produce a second emulsion, wherein the second reaction mixture, based on the total weight of the reaction mixture, comprises:

(b1) 1.0 to 80.0 wt.-%, preferably 10 to 70 wt.-%, in particular 30 to 60 wt.-%, of magnetic nanoparticles whose surface is preferably hydrophobized, wherein the magnetic nanoparticles preferably catalyze the polyaddition reaction of compounds with isocyanate groups and NCO-reactive groups to give polyurethanes; and

(b2) optionally from 0.0 to 70.0 wt.-% of at least one polymerization catalyst or initiator, preferably a catalyst which catalyzes the polyaddition reaction of compounds with isocyanate groups and NCO-reactive groups to polyurethanes; and

(b3) optionally 0.0 to 89.0 wt.-% of at least one hydrophobic release agent, wherein the release agent preferably has a Hansen parameter δₜ of less than 20 MPa^{1/2}; and

(b4) optionally from 0.0 to 10.0 wt.-% of at least one ultrahydrophobic compound other than the release agent, preferably an optionally fluorinated C₁₂₋₂₈ hydrocarbon, more preferably a C₁₄₋₂₆ alkane;

(iii) combining the first emulsion of step (i) with the second emulsion of step (ii); and

(iv) polymerizing the monomers; or

(B)

(i) Emulsifying a reaction mixture into a continuous aqueous phase, in particular water, which comprises at least one stabilizer, in particular at least one surfactant, the reaction mixture comprising, based on the total weight of the reaction mixture:

(a) from 10.0 to 99.0 wt.-% of a monomer mixture, composed, based on the total weight of the monomer mixture, of:

(a1) 2.5 to 19.0 wt.-%, in particular 5.0 to 12.0 wt.-%, of at least one monoethylenically unsaturated C₃₋₅-carboxylic acid monomer;

(a2) 76.0 to 97.5 wt.-%, in particular 85.0 to 95.0 wt.-%, of at least one monoethylenically unsaturated C₃₋₅-carboxylic acid C₁₋₁₀-alkyl ester monomer;

(a3) 0.0 to 5.0 wt.-%, in particular 0.0 to 3.0 wt.-%, of at least one monomer which carries at least two ethylenically unsaturated groups, preferably a divinylbenzene or a di- or triester of a C₂-C₁₀ polyol with ethylenically unsaturated C₃-C₅-carboxylic acids, in particular a di- or triester of a C₂-C₁₀-alkanediol or -triol with ethylenically unsaturated C₃-C₅-carboxylic acids,

(b) from 1.0 to 70.0 wt.-%, preferably from 1.0 to 30.0 wt.-%, of magnetic nanoparticles whose surface is preferably hydrophobized, wherein the magnetic nanoparticles preferably catalyze the polyaddition reaction of compounds having isocyanate groups and Catalyze NCO-reactive groups to form polyurethanes; and

(c) optionally from 0.0 to 70.0 wt.-% of at least one polymerization catalyst or initiator, preferably a catalyst catalyzing the polyaddition reaction of compounds with isocyanate groups and NCO-reactive groups to polyurethanes; and

(d) optionally, 0.0 to 89.0 wt.-% of at least one hydrophobic releasing agent, said releasing agent preferably having a Hansen parameter δₜ of less than 20 MPa^{1/2}; and

(e) optionally from 0.0 to 10.0 wt.-% of at least one ultrahydrophobic compound other than the release agent, preferably an optionally fluorinated C₁₂₋₂₈ hydrocarbon, more preferably a C₁₄₋₂₆ alkane;

(ii) optionally homogenizing the emulsion of step (i); and

(iii) polymerizing the monomers.

A further aspect is directed to the nanocapsules obtainable by the methods described above and their use for catalyzing polymerization reactions, in particular of polyurethanes.

Yet another aspect relates to agents and compositions containing the nanocapsules of the invention.

“At least one” as used herein means 1 or more, that is 1, 2, 3, 4, 5, 6, 7, 8, 9 or more. With respect to an ingredient, the indication refers to the type of ingredient, not the absolute number of molecules. Thus, “at least one release agent” means, for example, at least one type of release agent, i.e., one kind of release agent or a mixture of several different release agents can be used. The term, together with weights data, refers to all compounds of the type indicated which are included in the composition/mixture, i.e. that the composition does not contain any further compounds of this type beyond the stated amount of the corresponding compounds.

All percentages given in connection with the compositions described herein, unless explicitly stated otherwise, are wt.-%, based in each case on the mixture in question.

“Emulsion” or “mini-emulsion” as used herein refers to an oil-in-water (O/W) emulsion in which the emulsified phase is available in the form of droplets or particles, preferably of approximately spherical shape, in the continuous water phase. In this case, the droplets/particles of a mini-emulsion have an average size, with an approximately spherical shape an average diameter, in the size range of 50 to 500 nm, preferably 100 to 300 nm.

The term “nanocapsule” as used herein refers to the emulsified polymerized particles prepared by the methods described herein. These have the above-mentioned average size in the range of 50 to 500 nm, preferably 100 to 300 nm. The aforementioned averaged values refer to the z-average (“z-average”) from the dynamic light scattering according to ISO 22412: 2008. In the context of the present invention, the term “nanocapsule” may refer to both a core-shell nanostructure in which a shell of polymers includes the magnetic nanoparticles and the remaining constituents of the present invention, as well as a matrix-like nanostructure in which the magnetic nanoparticles and the other constituents according to the present invention are embedded in a polymer matrix. In both cases, the magnetic nanoparticles and the other constituents of the respective nanostructure as defined herein are referred to as “encapsulated.”

In various embodiments of the invention, the monomers for the capsule shell are chosen such that the copolymer obtainable from the monomer mixture has a theoretical glass transition temperature T₉ of 95° C. or more, in particular 100° C. or more, more preferably 105° C. or more, calculated analogously to the Fox equation. In particular, when a volatile propellant is used, i.e. one with a boiling point up to 200° C., these T_{g} values are preferred to ensure a sufficient barrier effect of the capsule shell.

“Glass transition temperature” or “T_{g}” as used herein refers to the temperature at which a given polymer transitions from a solidified glassy state to a rubbery state and awakens polymer segment mobility. It is related to the stiffness and free volume of a polymer and can be experimentally determined by known procedures such as the Dynamic Mechanical Thermal Analysis (DMTA) or the Differential Scanning calorimetry (DSC). Both methods are known in the art. It should be noted that, depending on the measurement method and the measuring conditions or the thermal history of the polymer sample, different glass transition temperatures can be obtained for an identical polymer system. In fact, the indication of a defined temperature already has a certain inaccuracy, since the glass transition typically takes place within a temperature range. In addition, glass transition temperatures of nanocapsules are experimentally difficult to access and not every determination method is suitable. The herein stated glass transition temperatures are therefore calculated theoretically analogous to the Fox equation, unless stated otherwise. In the following, the correspondingly calculated values of the glass transition temperature are sometimes referred to as “estimated.” When reaching or exceeding the glass transition temperature, the capsule shell becomes more and more expanded due to an increased mobility of the polymer and can thereby gradually lose at least part of its barrier effect, i.e. become more permeable to the encapsulated content. The thermolatency can thus be at least partially effected via the T_{g} of the shell polymer and by increasing the temperature above the T_{g}.

The Fox equation (cf. T. G. Fox, Bull. At the. Phys. Soc. 1 (1956) Page 123) states that the reciprocal glass transition temperature of a copolymer can be calculated using the proportions by weight of the comonomers used and the glass transition temperatures of the corresponding homopolymers of the comonomers:

$$\frac{1}{{T}_{g}} = {\sum }_{i = 1}^{n} \frac{{w}_{i}}{{T}_{g , i}}$$

In the general equation, n represents the number of monomers used, i the number of runs with the monomers used, wᵢ the mass fraction of the respective monomer i (in wt.-%) and T_{g,i} the respective glass transition temperature of the homopolymer from the respective monomers i in K (Kelvin).

The values for the glass transition temperatures of the corresponding homopolymers can also be taken from relevant reference texts (cf. J. Brandrup, E. H. Immergut, E. A. Grulke, “Polymer Handbook,” 4th edition, Wiley, 2003), for some selected monomers, the corresponding and relevant glass transition temperatures of the homopolymers used for calculations are indicated in the following: methyl acrylate (MA), T_{g}=10° C. methyl methacrylate (MMA), T_{g}=105° C.; ethyl acrylate (EA), T_{g}=−24° C.; ethyl methacrylate (EMA), T_{g}=65° C.; n-butyl acrylate (BA), T_{g}=−54° C.; n-butyl methacrylate (BMA), T_{g}=20° C.; n-hexyl acrylate (HA), T_{g}=57° C.; n-hexyl methacrylate (HMA), T_{g}=−5° C.; styrene (S), T_{g}=100° C.; cyclohexyl acrylate (CHA), T_{g}=19° C.; cyclohexyl methacrylate (CHMA), T_{g}=92° C.; 2-ethylhexyl acrylate (EHA), T_{g}=−50° C.; ethylhexyl methacrylate (EHMA), T_{g}=−10° C.; isobornyl acrylate (IBOA), T_{g}=94° C.; isobornyl methacrylate (IBOMA), T_{g}=110° C.; Acrylic acid (AA), T_{g}=105° C.; Methacrylic acid (MAA), T_{g}=228° C.

It should be noted that in the present case when using multiple vinylically or ethylenically unsaturated, radically polymerizable monomers (so-called “branching agents” or “crosslinker”) these are not included in the calculation of the glass transition temperature. The values calculated by means of the equation as described above are referred to herein as “theoretically calculated analogous to the Fox equation” or “estimated.”

The process described herein is based on a polymerization-induced phase separation, which is determined by the interaction with water and in which a hydrophobic compound is enclosed in a slightly less hydrophobic polymer shell. The formation of nanocapsules by phase separation is based on the poor solubility of a polymer in a solution. In this case, for example, an organic liquid to be included, serve as a solvent for the monomers, wherein the same liquid after the polymerization can no longer act as a solvent for the polymer.

In various embodiments of the invention, the Hansen parameter δ_{d} of the polymer of capsule shell 15-19, is preferably 16-18, more preferably about 17, the Hansen parameter δₚ is 10-14, preferably 1½, even more preferably about 12, and Hansen parameter δₕ is 13-17, preferably 14-16 more preferably about 15, especially 15.3. The Hansen parameter δₜ is preferably 23-28, preferably 24-27, more preferably 25-26. The Hansen parameter is always indicated herein by using unit MPa^{1/2} unless otherwise specified.

The Hansen parameter is a widely used parameter in polymer chemistry for the comparison of the solubility or miscibility of various substances. This parameter was developed by Charles M. Hansen to predict the solubility of one material in another. Here, the cohesive energy of a liquid is considered, which can be subdivided in at least three different forces or Interactions as follows: (a) Dispersion forces between the molecules δ_{d}. (b) Dipolar intermolecular forces between the molecules δ_{P} and (c) Hydrogen bridging bonds between the molecules δₕ. These three parameters can be combined into a parameter δₜ according to the formula δₜ²=δ_{d}²+δₚ²+δₕ². The more similar the Hansen parameter of different materials, the better they are miscible with each other. Unless otherwise indicated, the Hansen parameter values given herein refer to the values as reported or calculated by Hansen in Hansen Solubility Parameters. A User's Handbook, Vol. 2, Taylor & Francis Group, Boca Raton, 2007, especially at room temperature (20° C.). The determination of the Hansen parameters of capsule shell takes place in particular as described in Angew. Chem. Int. Ed. 2015, 54, 327-330.

For a mixture of solvents, the Hansen solubility parameters can be calculated with the volume fraction of the two solvents. The following equation can be used to calculate the parameter δ_{X} for two solvents S1 and S2, with x=h, d or p:

δₓ=(ϕ₁δₓ₁)+(ϕ₂δₓ₂)

In a 3D plot, the three solubility parameters for a solvent represent the coordinates of a single point in three-dimensional space. For polymers P, the three parameters represent the coordinates of the center of a “solubility sphere” of radius R₀ (Interaction radius). This sphere represents the area in which the polymer is soluble (for linear polymers) or where it can be swelled (in the case of a crosslinked polymer network).

The Hansen solubility parameters can thus be determined by swelling experiments in solvents of known Hansen parameters. If the polymer is soluble or swollen in the solvent, the Hansen parameter of the solvent is within the solubility sphere of the polymer. For two substances, for example the solvent S and the polymer P, the “distance” between the solubility parameters of these components can be calculated with the following equation (s. C. M. Hansen, Hansen Solubility. Parameters A User's Handbook, Vol. 2, Taylor & Francis Group, Boca Raton, 2007):

(Rₐ)₂=4(δ_{dS}−δ_{dP})²+(δ_{pS}−δ_{pP})²+(δ_{hS}−δ_{hP})²

A high affinity or solubility presupposes that Rₐ is smaller than R₀.

In order to obtain a phase separation during the polymerization and thus a core-shell structure, it is preferable to have a poor solubility of the polymer in the respective core material. Consequently, the determination of Hansen solubility parameters of the polymer used can be used to prevent good solubility of the polymer in the core material.

With the radius of the solubility sphere R₀ and the values of Rₐ of the core materials, the so-called relative energy difference (RED) of the considered system can be calculated:

RED=Rₐ/R₀

A RED value of 0 is not found for any energy difference of the compared materials. A value less than one indicates high affinity, and a value greater than one indicates low affinity between the materials. In other words, a RED value less than or equal to one indicates solubility, a RED value greater than one indicates incompatibility and thus no mixture. Accordingly, a high RED value should preferably result in comparing the core and shell substances to achieve phase separation during polymerization.

In various embodiments of the invention, the compound to be encapsulated or the mixture of compounds to be encapsulated satisfies the above relationship such that RED is >1. In particular, Rₐ/R₀>1, with R₀=8-15, especially 10-13, preferably 11-12, more preferably about 11.3, most preferably 11.3. Herein, R₀ and Rₐ, unless stated otherwise, are always in the unit MPa^{1/2}.

In the processes described herein, the mixture to be encapsulated, i.e. the magnetic nanoparticles and optionally the polymerization catalyst, the release agent, in particular propellant, and/or the ultrahydrophobic compound, under homogenization and/or polymerization conditions, preferably at room temperature (20° C.) and atmospheric pressure (1,013 mbar), is preferably liquid. “Liquid,” as used in this context under the conditions mentioned, includes all flowable substances, flowable homogeneous mixtures and flowable heterogeneous mixtures, including emulsions, dispersions or suspensions.

In various embodiments, it may be advantageous if the monomers of the monomer mixture in the mixture to be encapsulated under the emulsification/homogenization conditions are at least partially soluble. In different embodiments, the monomer mixture may therefore be used as a solution of the monomers in at least one hydrophobic compound, for example the release agent or propellants. Although not preferred according to the invention, the compound mixture to be encapsulated and the monomers may also be dissolved in an organic solvent and the resulting solution is emulsified/dispersed in the continuous phase in step (i).

The magnetic nanoparticles are particulate aggregates, which substantially consist of a magnetic metal or a magnetic derivative thereof. The magnetic metal can be selected from the group consisting of Sc, V, Cr, Fe, Co, Ni, Y, Zr, Mo, u, Mn, Pd, La, Ce, Pr, Nd, Gd, Tb, Dy, Ho, He, Tm, Lu, Ta, Os, Ir, Pt, Au, Eu, Sm, Yb, Al, Th and U. However, it may also be a combination of the aforementioned metals. Preferably, it is Co, Fe, Ni, La, Y, Mn or a combination of the foregoing. Alternatively, it can also be a semi-metal, such as boron (B). The term “derivative” in this context refers to an alloy of one of the abovementioned metals with one or more other elements or an oxide or carbide of one of the abovementioned elements. In various embodiments, the magnetic nanoparticles are capable of catalyzing or initiating the polymerization reaction of certain monomers or prepolymers, in particular the polyaddition reaction of compounds with isocyanate groups and NCO-reactive groups to polyurethanes. In different embodiments, the magnetic nanoparticles are magnetite nanoparticles.

In various embodiments, the magnetic nanoparticles have an average size, in case of an approximately spherical shape, an average diameter, in the range of >1 nm preferably >2 nm and/or <50 nm, preferably <25 nm, in particular <15 nm, i.e. for example >1 nm and <50 nm, preferably >1 nm and <25 nm, more preferably >2 nm and <15 nm. The sizes of the particles can be determined, for example, by means of transmission electron microscopy (TEM) and a statistical evaluation (for example according to Pyrz et al., Langmuir, 2008, 24 (20), 11,350-11,360).

According to various particularly preferred embodiments, the magnetic nanoparticles of the present invention are superparamagnetic.

In various embodiments, the magnetic nanoparticles of the present invention have a magnetization with values in the range of >60 emu/g, preferably >70 emu/g, especially >75 emu/g. For example, in various embodiments, the magnetic nanoparticles have a magnetization of at least 77 emu/g. The magnetization can be determined, for example, by means of a vibrating magnetometer (VSM) (Lu et al., Angew. Chem. Int. Ed. 2007, 46, 1,222-1,244; McCollam et al., Review of Scientific Instruments 2011, 82, 053909; Foner, J. Appl. Phys. 1996, 79 (8), 4,740-4,745).

In order for the magnetic nanocapsules and/or the release agent to be particularly effectively encapsulated, it is advantageous that they be hydrophobic so that they do not interact with the polymer formed from the monomers such that they swell excessively even under synthesis and storage conditions thereby become more permeable.

It is therefore preferred in various embodiments that the surface of the magnetic nanoparticles be modified such that they are hydrophobic. In the context of the present invention, the hydrophobization of the surface of the magnetic nanoparticles occurs by the binding of ligands to the surface of the particles. In principle, suitable for this purpose are all types of ligands capable of binding to the surface of the magnetic nanoparticles and at the same time of building a hydrophobic shell on their surface. Suitable ligands are known to the person skilled in the art. Without any limitation, however, in this context, for example, thiols, phosphonates, phosphates, acetylacetonates, fatty acids and the like are mentioned. It is preferred that the surface of the magnetic nanoparticles according to the present invention is modified with a ligand having an HLB value of less than 10 as determined by the Griffin method (Classification of surface active agents by HLB, J. Soc, Cosmet. Chem. 1, 1949). In particular, it is preferred that the surface of the magnetic nanoparticles according to the present invention is modified with a ligand having a Hansen parameter δₜ of less than 20, preferably less than 19, in particular less than 15; and/or has a Hansen parameter δₕ of less than 12, preferably less than 10, more preferably less than 6, in particular less than 2. For example, in various embodiments, the ligand may have a Hansen parameter δₕ of zero.

In various embodiments of the invention, the ligand satisfies the above relationship between Hansen parameters of the shell polymer and Hansen parameters of the ligand or mixture of ligand and release agent and, if present, of a catalyst/initiator such that RED >1. In particular, Rₐ/R₀>1, with R₀=8-15, especially 10-13, preferably 11-12, more preferably about 11.3, most preferably 11.3. In the context of the present invention, such modified nanoparticles are referred to as hydrophobized nanoparticles.

In various embodiments, the surface of the magnetic nanoparticles is modified with at least one saturated or unsaturated fatty acid having from 1 to 30 carbon atoms. Exemplary in this context are palmitoleic acid, oleic acid, Petroselinic acid, vaccenic acid, gadoleic acid, iscosenoic acid, cateloic acid, erucic acid, linoleic acid, α-linolenic acid, γ-linolenic acid, calendic acid, punicic acid, α-elaeostearic acid and β-elaeostearic acid. In particular, it is preferred that the surface is modified with a saturated or unsaturated fatty acid having a Hansen parameter δₜ of less than 20, preferably less than 19, in particular less than 15; and/or with a Hansen parameter δₕ of less than 12, preferably less than 10, more preferably less than 6, in particular less than 2. In various embodiments of the invention, the fatty acid satisfies the above relationship between Hansen parameters of the shell polymer and Hansen parameters of the fatty acid or mixture of fatty acid and release agent and, if present, catalyst/initiator such that RED is >1. In particular, Rₐ/R₀>1, with R₀=8-15, especially 10-13, preferably 1-1-12, more preferably about 11.3, most preferably 11.3. Methods of making such modified magnetic nanoparticles are known in the art.

(Latham, A H, M E Williams, Accounts of Chemical Research, 2008, 41 (3), 41 1-420; Bannwarth, M B, et al., Angewandte Chemie International Edition, 2013, 52 (38), 10,107-10,111). In various embodiments, the surface of the magnetic nanoparticles is modified with oleic acid.

In various embodiments, the nanocapsules according to the invention may, in addition to the magnetic nanoparticles, which catalyze or initiate the polymerization reaction of certain monomers or prepolymers, in particular the polyaddition reaction of Compounds with isocyanate groups and NCO-reactive groups to polyurethanes, additionally comprise at least one further polymerization catalyst or initiator. According to these embodiments, it is preferred that the at least one further catalyst/initiator compound has a Hansen parameter δₜ of less than 20, preferably less than 19, in particular less than 15; and/or has a Hansen parameter δₕ of less than 12, preferably less than 10, more preferably less than 6, in particular less than 2. For example, in various embodiments, the at least one catalyst/initiator may have a Hansen parameter δₕ of zero. In various embodiments of the invention, especially when used without the release agent, the catalyst/initiator compound satisfies the above relationship between Hansen parameters of the shell polymer and Hansen parameters of the catalyst/initiator such that RED is >1. In particular, Rₐ/R₀>1, with R₀=8-15, especially 10-13, preferably 11-12, more preferably about 11.3, most preferably 11.3.

It is further preferred that the hydrophobic compounds, i.e. the release agent, the catalyst/initiator and the ultrahydrophobic compound, do not show any severely interfering side reaction in the radical polymerization (such as by radical scavengers, such as phenols) or with the monomers (such as no Michael reaction). The hydrophobic compounds are therefore preferably inert under the conditions employed with respect to the monomers and the reactants used in the polymerization (with the exception of deliberately used reactive release agents, which are described in more detail below). Preferably, the hydrophobic compounds described above have an HLB value of less than 10 as determined by the method described by Griffin (Classification of surface active agents by HLB, J. Soc. Cosmet. Chem. 1, 1949). A compound to be encapsulated can be considered to be excessively disturbing in the polymerization if, even after the post-initiation or post-polymerization (see description below) a total monomer conversion of 80%, preferably 90% and particularly preferably 95% is not exceeded. The determination method is for example HPLC (High performance liquid chromatography). In addition, ideally the (headspace) gas chromatography can serve as a determination method, which can also be used to determine the encapsulation efficiency. In addition, this method not only allows the quantitative determination of the release kinetics, but also the determination of the conversion of most monomers. If in some cases not all used comonomers can be measured by chromatographic methods (difficult determination of the total monomer conversion), then the quantitative determination of individual comonomers is sufficient, which make up cumulatively at least 50% of the total monomer composition. In this case, a compound to be encapsulated is considered to be excessively disturbing if the cumulative conversion of at least 50% of the monomers used is <80%, preferably <90% and particularly preferably <95%.

In various embodiments, the at least one additional catalyst or initiator is a compound that can also catalyze or initiate the polymerization reaction of certain monomers or prepolymers. It may be, for example, known olefin catalysts, including metallocenes and ligands/complex compounds containing, for example, lanthanides, actinides, titanium, chromium, vanadium, cobalt, nickel, zirconium and/or iron, organometallic compounds, such as organic compounds based, on tin, Bismuth, or titanium, metathesis catalysts (Schrock, Grubbs, molybdenum, ruthenium), or organic compounds such as organic peroxides (such as those available as crosslinking peroxides under the trade names Perkadox® and Trigonox® from Akzo Nobel NV or Luperox® from Sigma Aldrich) or tertiary amines such as DABCO, DBU. Preferred organometallic compounds are thiolates, for example mercaptides of tin. Also preferred are salen (bis (salicylidene) ethylenediamine) and its derivatives, as described, for example, in Komatsu et al. (2008) Warden (Komatsu (2008) “Thermally latent reaction of hemiacetal ester with epoxide catalyzed by recyclable polymeric catalyst of salen-zinc complex and polyurethane main chain. Journal of Polymer Science Part A: Polymer Chemistry 46 (11): 3,673-3,681). Particular preference is given to catalysts for the synthesis of polyurethanes, for example organotin compounds, such as DBTL (Dibutyltin dilaurate), which is not preferred for reasons of toxicity, and especially tin neodecanoate (tributyltin neodecanoate). Other metal-containing catalysts are described, for example, in Schellekens et al. (Schellekens, Y., et al. 2014). “Tin-free catalysts for the production of aliphatic thermoplastic polyurethane.” Green Chemistry 16 (9): 4,401-4,407). In addition, those catalyst systems are preferred which have a high stability in water or have hydrolytic stability. In various embodiments, the at least one additional catalyst or initiator is a compound that is not tin-based. The catalyst/initiator is also not a catalyst/initiator for the polymerization of the monomers forming the capsule shell, i.e. different from such a catalyst/initiator.

It is preferred, as already described above, that the at least one further catalyst/initiator compound is a hydrophobic compound, i.e. has a Hansen parameter as indicated above. In those embodiments where the catalyst/initiator is sufficiently compatible with the capsule shell at elevated temperature to penetrate it, the use of a release agent may be dispensed with. The release mechanism is then based on the one hand, that the nanocapsules, depending on the glass transition temperature T_{g} of the copolymer are temperature-sensitive. Increasing the temperature leads to a higher mobility of the polymer chains in the shell and thereby to a widening of the polymer shell (increase in the free volume), which thereby becomes more permeable. On the other hand, at elevated temperature, the catalyst/initiator has then a softening effect on the capsule shell. However, it is preferred that the catalyst/initiator is used together with a release agent supporting this mechanism or additionally acting as a propellant.

Nanocapsules which according to the present invention do not comprise catalytically active magnetic nanoparticles preferably have at least one polymerization catalyst or initiator (b2). The at least one polymerization catalyst or initiator (b2) is preferably contained in the nanocapsules in particular if the nanocapsules do not comprise magnetite nanoparticles, for example no hydrophobized magnetite nanoparticles, for example no magnetite nanoparticles hydrophobized with oleic acid.

The release agent is selected in various embodiments such that the catalyst/initiator is sufficiently soluble therein. The solubility for liquid compounds is preferably 20 g/I at room temperature (20° C.) or solid compound at a temperature corresponding to the melting temperature of the compound Tₘ+20° C. The melting temperature can be determined according to the standard DIN EN ISO 11357-3: 2013-04 by means of DSC at a heating rate of 10 K/min. To determine the solubility, a Metrohm Photometer 662 equipped with a probe can be used to determine the light transmittance. For the measurement, visible light (entire spectrum) is then guided via optical fibers to the probe, which is immersed in the liquid sample. The light is emitted from the probe tip, travels through the sample solution, is reflected by a mirror, and then directed to the detector via optical fibers. Before reaching the detector, an optical filter can be used to allow the selective measurement of a particular wavelength. For such measurements, a wavelength of 600 nm can be used. An Ahlborn Almemo Multimeter was used to digitally record the transmissivity (analog output of the photometer) and a light transmittance of ≥98% (at the chosen wavelength) was assumed to be at complete solubility. In the case of using highly absorbent (colored) fabrics, the wavelength measuring range should be set so that the measurement is performed in a region of minimum excitation. In addition, in the case of a non-volatile catalyst in substantially lower boiling release agents, the solubility can be determined gravimetrically (dry weight of a saturated solution). Further quantitative methods, such as those based on chromatography or spectroscopy, are known to the skilled in the art and/or can be taken from the literature.

The release agent is also hydrophobic. Preferably, therefore, the release agent has an HLB value of less than 10 as determined by the method described by Griffin (Griffin, W. C.: Classification of surface active agents by HLB, J. Soc. Cosmet. Chem. 1, 1949). Furthermore, it is preferred that the release agent has a Hansen parameter δₜ of less than 20, more preferably less than 19, even more preferably less than 15; and/or has a Hansen parameter δₕ of less than 12, preferably less than 10, more preferably less than 6, in particular less than 2. For example, in various embodiments, the at least one release agent may have a Hansen parameter δₕ of zero. In various embodiments of the invention, release agent satisfies the above relationship between Hansen parameters of the shell polymer and Hansen parameters of the release agent or mixture of release agent and catalyst/initiator such that RED is >1. In particular, Rₐ/R₀>1, with R₀=8-15, especially 10-13, preferably 11-12, more preferably about 11.3, most preferably 11.3.

In various preferred embodiments, the release agent is liquid under homogenization and/or polymerization conditions, preferably at room temperature (20° C.) and atmospheric pressure (1,013 mbar).

In various embodiments, the release agent may be a reactive release agent that is at least partially polymerized in the catalyst-mediated polymerization after the capsules are broken. Examples of suitable compounds include, but are not limited to, polyfunctional nucleophilic compounds such as hydroxyl group-containing compounds, particularly the various polyols including polyether polyols such as polypropylene glycol, polytetrahydrofuran, polyesters, and also polyamides and polydimethylsiloxane, as well as castor oil, cardanol derivatives, where no phenolic hydroxyl groups are present, and other long-chain hydrophobic polyols and monoalcohols and (hydrophobic) epoxy resins.

In various particularly preferred embodiments, the release agent is a hydrophobic propellant, preferably a hydrocarbon, having a boiling point of 50 to 200° C., preferably 60 to 150° C., more preferably 80 to 120° C. The indicated boiling point refers to the boiling point under standard conditions, i.e. at normal pressure (1,013 mbar). The propellant is in various embodiments a C₆₋₁₀ hydrocarbon, preferably a C₆₋₁₀ alkane, in particular isooctane (2,2,4-trimethylpentane), or a mixture of the aforementioned compounds. The propellant is preferably liquid under standard conditions and may serve to dissolve the monomers and, optionally, the catalyst compound therein. The boiling points provided make it possible to break up the nanocapsules by heating to temperatures above these boiling points, since then the propellant evaporates and the increasing pressure causes the nanocapsules to burst open.

In the following, the invention will be described by reference to certain specific embodiments. However, it is not intended that the invention be limited to these embodiments, but that it may be readily adapted for the use of other monomers, stabilizers/surfactants, and initiators. Incidentally, this also applies to the explicitly mentioned and exemplarily tested release/propellants and catalysts/initiators. Such embodiments are also within the scope of the invention.

In a first step of the process according to the invention, a stabilized emulsion is prepared. The emulsion contains the monomer mixture described above and at least one stabilizer, in particular a surfactant, the magnetic nanoparticles, optionally the release agent, optionally at least one further catalyst/initiator substance and optionally one or more ultrahydrophobic compounds in the form of an emulsion in an aqueous solvent. The aqueous solvent contains as main component (more than 50, in particular more than 80% by volume) of water or may consist entirely of water. In various embodiments, the aqueous solvent may include one or more non-aqueous solvents, for example, selected from monohydric or polyhydric alcohols, alkanolamines, or glycol ethers, provided that they are miscible with water in the given concentration ranges.

These additional solvents are preferably selected from ethanol, n- or isopropanol, butanol, glycol, propanediol or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or ethyl ether, diisopropylene glycol monomethyl or ethyl ether, methoxy, ethoxy or butoxy triglycol, 1-butoxyethoxy-2-propanol, 3-methyl-3-methoxybutanol, propylene glycol t-butyl ether and mixtures thereof. In the aqueous solvent, such solvents can be used in amounts of between 0.5 and 35 wt.-%, but preferably less than 30 wt.-% and in particular less than 25 wt.-%.

The monomers used in the described processes are in particular ethylenically unsaturated carboxylic acids and their alkyl esters.

In various embodiments, the at least one monoethylenically unsaturated C₃-C₅ carboxylic acid monomer is selected from methacrylic acid (MAA), acrylic acid (AA), fumaric acid, methylmaleic acid, maleic acid, itaconic acid or mixtures of two or more thereof. Particularly preferred are methacrylic acid (MAA), acrylic acid (AA) or mixtures thereof. Most preferred is methacrylic acid. These are, based on the monomer mixture, in particular in amounts of 2.5 to 19 wt.-%, preferably 5 to 12 wt.-%.

In various embodiments, the at least one monoethylenically unsaturated C₃₋₅-carboxylic acid C₁₋₁₀-alkyl ester monomer is an acrylic acid or methacrylic acid alkyl ester or a mixture thereof. Preference is given to methacrylic acid-C₁₋₅-alkyl ester monomers, in particular methyl methacrylate (MMA), methacrylic acid-n-butyl ester (BMA) or a mixture thereof. Very particular preference is given to a mixture of methyl methacrylate and methacrylic acid n-butyl ester, in particular in a weight ratio of 3.5:1 to 16:1, preferably 6:1 to 16:1. The alkyl radicals can generally be straight-chain or branched, unless stated specifically. These monomers are used, based on the monomer mixture, in particular in amounts of 76 to 97.5 wt.-%, preferably 85 to 95 wt.-%.

The monomer carrying at least two ethylenically unsaturated groups may generally be any compound carrying two ethylenically unsaturated groups, for example two vinyl groups. Examples of suitable compounds include, but are not limited to, divinyl aromatics such as, in particular, divinylbenzenes or multiple esters of a polyol with ethylenically unsaturated carboxylic acids such as, in particular, di- or triesters of a C₂-C₁₀ polyol with ethylenically unsaturated C₃-C₅ carboxylic acids. The latter are in various embodiments to diesters of methacrylic acid or acrylic acid with 1,3-propanediol, 1,4-butanediol or 1,5-pentanediol, in particular a methacrylic acid ester of 1,4-butanediol. Preference is given to di- and triacrylates or di- and trimethacrylates of polyhydric alcohols.

The abovementioned compounds having at least two ethylenically unsaturated groups serve as crosslinkers in the monomer mixtures. The crosslinkers used are related to the monomer mixture in amounts of up to 0 to 5 wt.-%, preferably up to 4.5 wt.-%, more preferably to 4 wt.-%.

In various embodiments of the invention, with the monomer mixture, the magnetic nanoparticles, optionally the at least one further catalyst/initiator substance and optionally the release agent in step (i), an ultrahydrophobic compound, in particular a C₁₂₋₂₈ hydrocarbon, more preferably a C₁₄₋₂₆ alkane, such as hexadecane, are emulsified in the continuous phase. Also, C₁₄₋₂₆ monoalcohols or monocarboxylic acids or fluorinated derivatives of the aforementioned may be suitable. The catalyst can be present, for example, dissolved in these. In various embodiments, the ultrahydrophobic compound may also be a C₁₂₋₂₈ hydrocarbon copolymerizable into the capsule shell or matrix; possible compounds include, but are not limited to, lauryl (meth)acrylate (LA). LMA), tetradecyl (meth) acrylate (TDA or TDMA), hexadecyl (meth) acrylate (HDA or HDMA), octadecyl (meth) acrylate (ODA or ODMA), eicosanyl (meth) acrylate, behenyl (meth) acrylate and mixtures thereof. If such ultra hydrophobic polymerizable compounds are used, these are not included in the calculation of the glass transition temperature analogously to the Fox equation (see above). These ultrahydrophobic compounds are compounds other than the release agent, typically those which have a boiling point >200° C. under standard conditions. “Ultra-hydrophobic” as used herein in connection with the compounds described above means that the corresponding compound has a solubility in water at 60° C. of less than 0.001 wt.-% as determined by the method described by Chai et al (Ind. Closely. Chem. Res. 2005, 44, 5,256-5,258).

In various further embodiments of the invention, it is also possible with the monomer mixture in step (i) to emulsify further polymerizable compounds, for example vinylically unsaturated monomers, in particular styrene, into the continuous phase. If such additional polymerizable compounds are used, the amount is not more than 50 wt.-%, based on the monomer mixture as defined above.

In certain preferred embodiments, the monomer mixture used is a mixture of:

(a) 2.5 to 19.0 wt.-%, in particular 5.0 to 12.0 wt.-% of methacrylic acid (MAA);
(b) 70.0 to 80.0 weight percent, in particular 72.5 to 80.0 weight percent, of methyl methacrylate (MMA);
(c) 6.0 to 17.5 wt %, especially 5.0 to 12.5 wt %, of n-butyl methacrylate (BMA); and
(D) 0.0 to 5.0 wt.-%, in particular 0.5 to 3 wt.-%, of 1, 4-butanediol dimethacrylate (BDDMA).

Such mixtures provide a polymer having the desired glass transition temperature (calculated as described above analogously to the Fox equation), for example of >95° C., in particular >100° C. At the same time, these monomer mixtures are hydrophobic enough to give stable mini-emulsion droplets.

In various embodiments, the emulsion 1 prepared in step (i) of the process according to the invention contains from 0 to 70.0 wt.-%, preferably from 1.0 to 30.0 wt.-%, more preferably from 0.1 to 15 wt.-% magnetic nanoparticles as defined above; from 0.0 to 70.0 wt. %, preferably from 1.0 to 70.0 wt. %, more preferably from 5.0 to 70.0 wt. % of at least one polymerization catalyst or initiator as defined above; 0.0 to 89.0 wt. %, preferably 1.0 to 89.0 wt. %, more preferably 5.0 to 89.0 wt. %, particularly preferably 10.0 to 89.0 wt.-%, particularly preferably 20.0 to 89.0 wt. %. of at least one hydrophobic releasing agent as defined above; and from 0.0 to 10.0 wt.-%, preferably from 1.0 to 10.0 wt.-%, in particular from 5.0 to 10.0 wt.-%, of at least one ultrahydrophobic compound other than the release agent.

In step (i) and, if appropriate, step (ii) of the process at least one stabilizer is also used. The term “stabilizer” as used herein refers to a class of molecules that can stabilize the droplets in an emulsion, i.e. by preventing coagulation and coalescence. The stabilizer molecules can be attached to the surface of the droplets or interact with those. In addition, (polymerizable) stabilizers are used, which can react covalently with the monomers used. If polymerizable stabilizers are used, they are not included in the calculation of the glass transition temperature analogously to the Fox equation (see above). Stabilizers generally contain a hydrophilic and a hydrophobic portion, wherein the hydrophobic part interacts with the droplet and the hydrophilic part is oriented towards the solvent. The stabilizers may be, for example, surfactants and may carry an electrical charge. In particular, they may be anionic surfactants, for example sodium dodecyl sulfate (SDS).

Alternative stabilizers that can be used in the processes described herein are known to those skilled in the art and include, for example, other known surfactants as well as polymeric protective colloids, such as polyvinyl alcohol (PVOH) or polyvinylpyrrolidone (PVP). By means of the stabilizers used in the process according to the invention in the emulsification and optionally homogenization step colloidally stable heterophasic systems may be produced.

Accordingly, in some embodiments, the mixtures described herein may also contain other protective colloids, such as, for example, hydrophobically modified polyvinyl alcohols, cellulose derivates or vinylpyrrolidone-based copolymers. A detailed description of such compounds can be found, for example in Houben-Weyl, Methoden der Organischen Chemie, Vol. 14/1, Makromolekulare Stoffe, Georg-Thieme-Verlag, Stuttgart, 1961, pages 411-420.

The total amount of stabilizer/surfactant is typically up to 30 wt.-%, preferably 0.1 to 10 wt.-%, more preferably 0.2 to 6 wt.-%, based on the total amount of monomers or, if separate emulsions are used in the manufacture, of the hydrophobized magnetic nanoparticles.

The stabilizer can be used in the form of an aqueous solution. This solution may be compositionally similar to the composition of the continuous phase as defined above.

In various embodiments of the present invention, the preparation of the magnetic nanohybrid particles according to the invention takes place via a combined mini-emulsion/emulsion polymerization process.

In one embodiment, the first reaction mixture (a) is produced in a step (i) by emulsifying the above-described components (a1), (a2) and (a3) in a continuous aqueous phase. The emulsion is prepared by mixing the respective different ingredients, for example with an Ultra-Turrax.

The preparation of a second reaction mixture (b) takes place in a step (ii) analogously to step (i) with the constituents (b1), (b2), (b3) and (b4) described above.

The reaction mixtures or mini-emulsions, i.e. the first mini-emulsified reaction mixture from step (i) and the second mini-emulsified reaction mixture from step (ii) are then combined together in a step (iii). The combining of the two mini-emulsions can mean a direct mixing together of the two mini-emulsions. However, the combining of the two mini-emulsions can also be done via the production of a further mini-emulsion.

Alternatively, the preparation of the emulsion may also be accomplished by emulsifying the monomer mixture and all other ingredients, i.e. in particular the components to be encapsulated, in a single step. The emulsion is in this case prepared by mixing the respective different constituents, for example with an Ultra-Turrax, and optionally subsequently homogenized to produce a mini-emulsion. The homogenization and thus the production of a mini-emulsion takes place by a high shear process, for example by means of a high-pressure homogenizer, for example with an energy input in the range from 10³ to 10⁵ J per second per liter of emulsion and/or shear rates of at least 1,000,000/s. Shear rates can be readily determined by one skilled in the art by known methods.

The high shear process, as used herein, may be by any known method of dispersing or emulsifying in a high shear field. Examples of suitable processes can be found, for example, in DE 196 28 142 A1, page 5, lines 1-30, DE 196 28 143 A1, page 7, lines 30-58, and EP 0 401 565 A1.

In a subsequent step, the polymerization of the respective contained monomers takes place. The polymerization is carried out according to the present invention with a suitable polymerization process, in particular by means of radical polymerization. For this purpose, polymerization initiators can be used. Useful initiators include, for example, thermally activatable, radiation-activatable initiators, such as UV initiators, or redox-activatable initiators, and preferably selected from radical initiators. Suitable free radical initiators are known and available and include organic azo or peroxy compounds. The initiators are preferably water-soluble. When polymerization is initiated by a water-soluble initiator, free radicals are generated in the aqueous phase and diffuse to the water/monomer interface to initiate polymerization in the droplets. Examples of suitable initiators include peroxodisulfates, such as potassium peroxodisulfate (KPS), but are not limited thereto.

The polymerization may be carried out at elevated temperature, for example a temperature in the range of 10-90° C., preferably 20-80° C., more preferably 40-75° C. and most preferably 60-75° C. The polymerization can take place over a period of 0.1 to 24 hours, preferably 0.5 to 12 hours, more preferably 2 to 6 hours.

In general, the polymerization takes place under conditions which are compatible with the encapsulated active substances.

The term “about” as used herein in connection with a numerical value refers to a variance of ±20%, preferably ±10%, more preferably ±5% of the corresponding value. Thus, “about 70° C.” means 70±14, preferably 70±7, more preferably 70±3.5° C.

The amount of residual monomers can also be carried out chemically by post-polymerization, preferably by the use of redox initiators, such as those described in DE-A 44 35 423, DE-A 44 19 518 and DE-A 44 35 422. Suitable oxidizers for post-polymerization include, without limitation: hydrogen peroxide, t-butyl hydroperoxide, cumene hydroperoxide, or alkoxy peroxosulfates. Suitable reducing agents include, without limitation: sodium disulfite, sodium bisulfite, sodium dithionite, sodium hydroxymethanesulfite, formamidinesulfinic acid, acetone bisulfate, ascorbic acid and reducing saccharides, and water-soluble mercaptans such as mercaptoethanol. The post-polymerization with a redox initiator can be carried out in a temperature range from 10 to 100° C., in particular from 20 to 90° C. The redox agents may be added independently or continuously over a period of 10 minutes to 4 hours. In order to increase the effectiveness of the redox agents, soluble salts of metals having different valences, such as iron, copper or vanadium salts, may be added to the reaction mixture. Usually, complexing agents which keep the metal salts in solution under the reaction conditions are also added.

In order to control the molecular weight of the polymers, a chain length regulator can be used. Suitable compounds are known in the art and include, for example, various thiols, such as 1-dodecanethiol. In different embodiments in particular those chain length regulators are used, which can be consumed (polymerized in) in a reaction to be catalyzed by the magnetic nanohybrid particles according to the invention. The chain length regulators can be used in the quantities necessary to control the chain length to the desired extent. Typical amounts are in the range of 0.1 to 5 wt.-%, preferably about 0.3 to 2.0 wt.-%, more preferably about 0.5 to 1.0 wt.-% based on the total monomer mass.

In a further aspect, the invention relates to the nanocapsules, which may be obtained by means of the processes herein described. These may, in various embodiments, include magnetic nanoparticles, optionally one or more release agents, especially propellants, optionally one or more additional catalysts/initiators, and optionally one or more ultra-hydrophobic compounds. In particularly preferred embodiments, the magnetic nanoparticles with oleic acid are hydrophobized magnetite nanoparticles and the optional propellant is isooctane and the ultrahydrophobic compound is hexadecane.

The content of the nanocapsules of the invention can be released by increasing the temperature. On the one hand, this temperature—dependent release of the capsule contents can be achieved by magnetically induced heating of the magnetic nanoparticles inside the nanocapsules. In addition to the above mobility increase over T_{g} of the polymer chains in the shell or matrix, either the barrier effect of the shell or matrix is weakened by swelling and thereby widening due to increasing compatibility with the encapsulated compounds or, in the event that a propellant is used, the polymer shell is broken up and the contents released when the temperature rises above the boiling point of the propellant. In connection with the nanocapsules and because of interactions with the polymer, for the release it may also be necessary to select a temperature which is up to 50° C. above the actual boiling point of the propellant.

The nanocapsules described herein may find application in the catalysis of a variety of processes, particularly polymerization processes. Nanocapsules which, according to the present invention, comprise exclusively the magnetic nanoparticles, in particular magnetite nanoparticles hydrophobized with oleic acid, as catalytically active constituents, i.e. which comprise no further catalyst/initiator compound, are particularly suitable for use in conjunction with polyurethanes which have to be polymerized in a controlled manner in application. Accordingly, such nanocapsules can be used as constituents of numerous compositions containing such polyurethanes. These may be, for example, adhesives or polyurethane-based coating compositions. It is also conceivable to use nanocapsules according to the present invention containing titanium-based catalysts for condensation reactions, for example of silanes or silane-containing polymers. Further fields of application are the polymerization of epoxides, benzoxazines and metathesis systems. Particularly preferred is the use in crosslinking systems, such as elastomers and especially duromers. Generally the application fields include adhesives, sealants, coatings and infusion resins.

The compositions containing the nanocapsules described herein thus further contain, in various embodiments, at least one polyisocyanate or NCO-functional prepolymer and at least one compound having at least two NCO-reactive groups, especially a polyol. The catalyst, i.e. the magnetic nanoparticles and/or additional catalyst/initiator compounds then catalyze, upon release, the reaction between the isocyanate (NCO) groups and the NCO-reactive groups, typically hydroxyl groups, which react in a polyaddition to form urethane groups. As a result, the polyurethane polymers are formed from the monomers or prepolymers. It goes without saying that prepolymers having NCO-reactive groups, for example OH-functional prepolymers, can be used in addition to or instead of the NCO-functional prepolymers described. As polyisocyanates and polyols, all compounds commonly used in connection with the polyurethane synthesis may be used.

Of course, in addition to the described nanocapsules, the compositions may also contain other conventional ingredients of such agents.

In principle, all embodiments disclosed in connection with the nanocapsules and the agents of the invention are also applicable to the described processes and uses, and vice versa. For example, it is understood that all of the specific nanocapsules described herein are applicable to the aforementioned agents and methods and can be used as described herein.

The following examples serve to illustrate the invention, but the invention is not limited thereto.

### EXAMPLES

Materials: All monomers, methyl methacrylate (MMA, Merck, >99% stab.), butyl methacrylate (BMA, Merck, >99% stab.), methacrylic acid (MAA, Acros, 99.5% stab) and 1,4-butanediol dimethacrylate (BDDMA, Sigma Aldrich, 95%) were used as obtained without further purification. Sodium dodecyl sulfate (SDS, Lancaster, 99%), hexadecane (HD, Merck >99%) and the initiator potassium peroxodisulfate (KPS, Merck, for analysis) were used as obtained. The matrix-forming monomers Desmodur Z4470 (trifunctional isocyanate, Bayer, 70% in butyl acetate) and castor oil (hydroxyl number=158 mg KOH/g, VWR International) were used as received. Isooctane (IO, >99.5%, Carl Roth) and dimethyl tin dineodecanoate (Fomrez UL-28, Momentive, 50% in acetone) were used as received. Deionized water was used for all experiments.

Materials magnetite nanoparticles: ferrous chloride tetrahydrate (Merck, >99%), iron (III) chloride hexahydrate (VWR, >99), ammonia sol. (25%, reisnt).

Production of Magnetic Nanocapsules

Synthesis of Magnetite Nanoparticles

12.01 g (60 mmol) of iron (II) chloride tetrahydrate and 24.36 g (90 mmol) of iron (III) chloride hexahydrate were placed in a 500 mL three-necked flask equipped with stirrer and reflux condenser and dissolved in 100 mL of distilled water. Subsequently, 40 mL of a 25% ammonia solution were added dropwise at room temperature and with constant stirring. Finally, 4 g (14.2 mmol) of oleic acid were added and the reaction mixture heated to 70° C. for 1 h. Subsequently, the temperature was increased to 110° C. for 2 h. After the reaction time and cooling to room temperature, the black precipitate was separated from the matrix using a super magnet, washed with demineralized water and dried at 40° C. in a vacuum oven overnight.

Representation of the Magnetic Nanocapsules by Mini-Emulsion Polymerization

The magnetic nanocapsules with magnetite loading between 1% and 10% were prepared by a mini-emulsion process. For the disperse phase of the mini-emulsion, 4 g of a monomer mixture consisting of 3 g of MMA (75 wt.-%), 0.4 g of BMA (10.25 wt.-%), 0.4 g of MAA (10 wt.-%) and 0.1 g crosslinker (BDDMA, 2.5 wt.-%) were dissolved with 250 mg HD in 2 g of the core material.

A solution of 22 g of distilled water and 23 mg of SDS was then added to the hydrophobic mixture and homogenized for three minutes with an Ultraturax (16,000 rpm) for pre-emulsification. By introducing high shear forces with a Branson Sonifier 450-D with a ½-inch tip for 120 s (10 s pulse, 5 s pause) the mini-emulsion was then produced under ice-cooling, and placed in a 50 mL round bottom flask. After reaching the polymerization temperature (70° C.), a solution of 80 mg KPS in 2 mL of water was added and polymerized with stirring for 5 h. The particle sizes of the emulsions produced are between 177 and 203 nm.

TABLE 1
Magnetite loading for mini-emulsion polymerization

| | Hexadecane (g) | Isooctane (g) | Magnetite (g) |
|---|---|---|---|
| MOA* 1** | 0.25 | 1.98 | 0.02 |
| M0A 5 | 0.25 | 1.9 | 0.1 |
| MOA 10 | 0.25 | 1.8 | 0.2 |

*MOA = magnetite oleic acid;
**1 = wt % magnetite

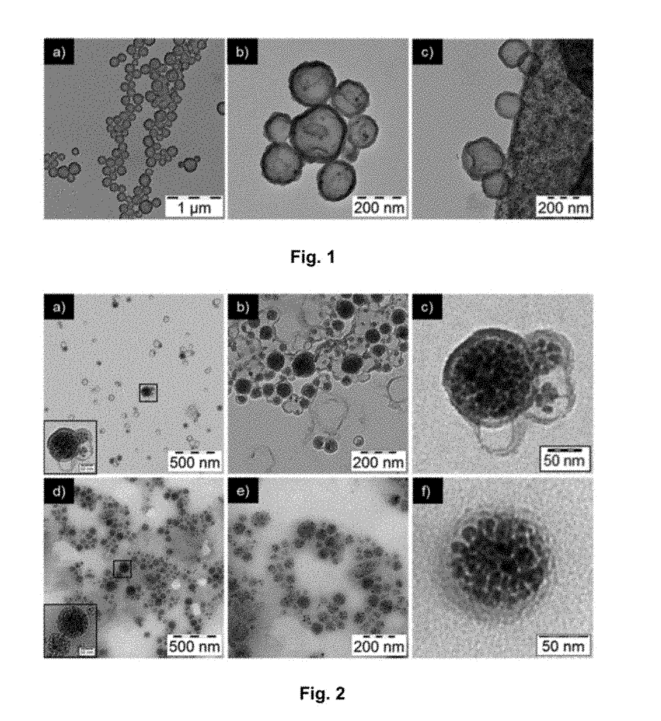

FIG. 1 shows the morphology of the sample MOA 10 at different resolutions. The capsules have a very high uniformity, as well as a core-shell structure. FIG. 1b further shows that magnetite particles are present in the nanocapsules.

Representation of the Magnetic Nanocapsules by Means of Emulsion Polymerization

For a mini-emulsion A, 0.769 g of MMA, 0.103 g of BMA and 0.103 g of MAA were mixed with 0.0256 g of the crosslinker BDDMA with 0.03 g of hexadecane. To the hydrophobic mixture, a solution of 24 g of distilled water and 10 mg of SDS was then added and homogenized for three minutes with an Ultraturax (16,000 rpm) for the pre-emulsification. By introducing high shear forces with a Branson Sonifier 450-D with a ½-inch tip, the monomer-mix emulsion was then produced for 120 s (10 s pulse, 5 s rest) with ice-cooling.

For a mini-emulsion B, the amounts of hydrophobized iron oxide nanoparticles indicated in Table 2 were dispersed in isooctane in an ultrasonic bath for 30 minutes and, depending on the sample, mixed with 0.769 g of Fomrez. Subsequently, a solution of 24 g of distilled water and 25 mg of SDS was added. The two-phase system was mini-emulsified with a Branson Sonifier 450-D with ½-inch tip for 180 s (10 s pulse, 5 s rest) with ice cooling.

TABLE 2
Magnetite loading for emulsion polymerization

| | Magnetite [g] | Isooctane [g] | Fomrez [g] |
|---|---|---|---|
| LMOA*F** | 1 | 2 | 0.0769 |
| HMOA***F | 2 | 1 | 0.0769 |
| LMOA | 1 | 2 | — |
| HMOA | 2 | 1 | — |

*LMOA = magnetic polymer/hybrid particles with low magnetite loading
**F = Fomrez
***HMOA = magnetic polymer/hybrid particles with high magnetite loading

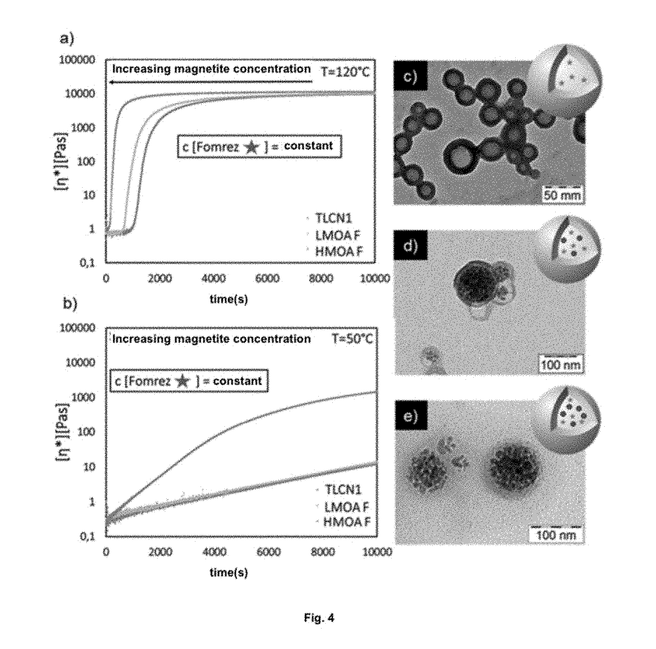

Both prepared mini-emulsions A and B were placed in a 100 mL one-necked flask, stirred for 5 minutes at room temperature and treated with a solution of 0.5 g of distilled water and 20 mg of KPS. Finally, the mixture was heated to 80° C. and polymerized with stirring for 8 h. The size of the particles, determined by dynamic light scattering, amounts to 109 m with a polydispersity index of 0.19 for LMOA F and to 87 nm for HMOA F with a distribution of 0.14. FIG. 2 shows the morphology of the capsules thus prepared, where a-c are the low-magnetite-content capsules (LMOA F) and d-e are the high magnetite-content particles (HMOA F). The morphology of the LMOA capsules without catalyst is similar to the catalytic, magnetic nanocapsule LMOA F (FIG. 4). The amount of magnetite is sufficiently low, so that uniform core-shell structures have formed. The magnetite is distributed homogeneously in the polymer matrix as expected. The particle sizes are at 104 nm with a polydispersity index of 0.19. The Hansen parameter δ_{d} of the polymer of the capsule shell is about 17 MPa^{1/2}, the Hansen parameter δₚ is about 12 MPa^{1/2}, and the Hansen parameter δₕ is about 15.3 MPa^{1/2}.

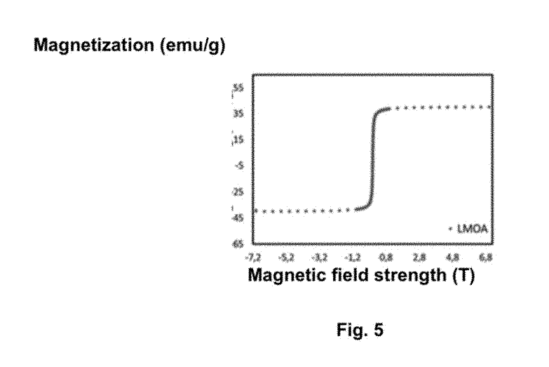

For thermal analysis of the magnetic nanocapsules with catalyst and high (HMOA F) and low (LMOA F) magnetite loading and the LMOA nanocapsules, TGA measurements were performed and compared with the nanocapsules without magnetite particles. The nanocapsules without magnetite show at 120° C. a mass loss of about 21%, which is due to the evaporation of the isooctane. In the magnetic nanocapsules, this loss of mass is not recognizable. The decomposition of organic material starts for LMOA F and HMOA F at ca. 150° C. and for the nanocapsules without magnetite loading at approx. 300° C. As expected, the polymer content of the nanocapsules without magnetite loading is significantly higher than that of the magnetic nanocapsules. This is further illustrated by the comparison of residues, which are only 8% for nanocapsules without magnetite loading, 54% for LMOA F and 64% for HMOA F, due to the higher inorganic content in these samples. The residue of LMOA amounts to approx. 58%. The saturation magnetizations of the LMOA sample, which were calculated from the hysteresis curve shown in FIG. 5, is 48 emu/g and is slightly decreased due to the presence of the polymer shell compared to the saturation magnetization of the pure magnetite nanoparticles.

Rheology Measurements

The rheology measurements were carried out under isothermal conditions at 50° C. and 120° C. and the curing reaction of the polyurethane composite was monitored. Thermolatent capsules without magnetite in the matrix serve as a reference.

Magnetic Nanocapsules Containing Catalyst

1 g castor oil (OH number=158) was added as normal with 0.1 wt.-% of Fomrez, based on the amount of castor oil used, and mixed with 0.9945 g of IPDI trimer (NCO number=355). For the LMOA F sample, the amount of lyophilized powder weighed into the castor oil is 28.12 mg and for the HMOA F particles 41.12 mg.

The curing reaction was monitored at constant temperature by measuring the complex viscosity, as shown in FIG. 4.

At 50° C., the samples with the non-magnetite nanocapsules and the LMOA F nanocapsules show a modest increase in viscosity over time. The final viscosity of the LMOA F is so low that it is not possible to process the components even after several hours under these conditions. Both samples show a nearly identical behavior. Although the catalyst concentration is the same in all three samples, the sample with HMOA F shows a completely different behavior. The final viscosity is two orders of magnitude higher, which could be due to the morphology of the particles. Due to the large amount of magnetite particles in the polymer no core-shell structures are formed, which is why the catalyst is not shielded by a barrier, but is distributed freely in the polymer. For this reason, it can more easily diffuse out of the polymer and catalyze the polyurethane reaction.

Subsequently, the temperature was raised to 120° C. The sample with the nanocapsules without magnetite has an induction phase of approx. 15 minutes before the curing reaction is catalyzed abruptly. In the sample with the LMOA F nanocapsules, the catalysis of the reaction also takes place abruptly, but the induction phase is significantly shorter at 10 minutes. In contrast, the HMOA F capsules do not even show an induction phase, but catalyze the reaction immediately. One reason for this could be catalytic properties of oleic acid, which additionally accelerates the curing reaction. Therefore, the possible catalysis by magnetite is considered in more detail below.

Magnetic Nanocapsules without Catalyst

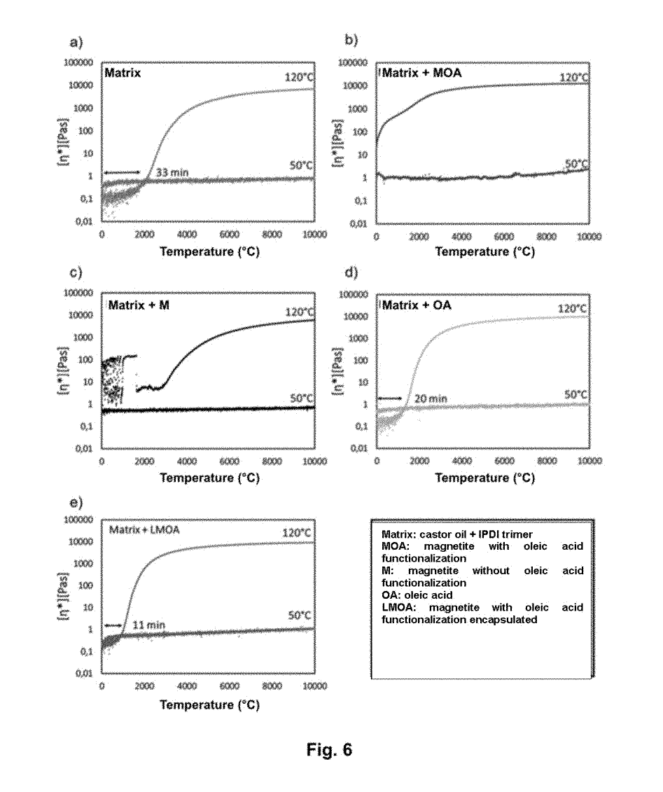

The measurements made for the further elucidation of catalysis are shown in FIG. 6. The pure PU matrix serves as reference again. (FIG. 6a). The magnetite concentration at this time amounts to 1 wt.-% of magnetite, based on the polyol, for all samples in order to ensure the comparability of the results.

1 g castor oil (OH number=158) was mixed with 1 wt.-% of magnetite, based on the amount of castor oil used, and mixed with 0.9945 g of IPDI trimer (NCO number=355) as standard. The exact quantities of the catalysts used are shown in Table 3.

TABLE 3
Weights of the magnetic, catalytic nanocapsules in the polyol

| | MOA | M | OA | LMOA |
|---|---|---|---|---|
| Mass (mg) | 10 | 10 | 10 | 21.16 |

Accordingly, 1 wt.-% of magnetite hydrophobized with oleic acid was first stirred into the castor oil and mixed with isocyanate. The curing reaction was monitored at 50° C. as well as at 120° C. (FIG. 6b). At 50° C. magnetite shows no catalytic activity and is therefore inactive. At 120° C., the reaction is accelerated directly and stepwise from the beginning, which confirms the assumption that the functionalized magnetite also contributes to the catalysis of the reaction. The starting viscosity is much higher than for the matrix. Since it is not clear whether the iron oxide or the oleic acid deposited thereto is responsible for the catalysis, non-functionalized magnetite was prepared and also used as a catalyst for the hardening reaction (FIG. 6c). At 50° C., the magnetite shows no activity and even at 120° C. no clear acceleration of the reaction can be seen. However, the compatibility of the inorganic magnetite with the organic matrix is very low, which is why the measurement varies greatly.

FIG. 6d shows oleic acid as a reaction accelerator of curing. The oleic acid, in contrast to the previously used heterogeneous catalysts is a homogeneous catalyst. For the comparability of the samples, the concentration of oleic acid amounts to the proportion attached to 1 wt.-% of magnetite. Again, no catalysis of the reaction takes place at 50° C. At 120° C., however, an abrupt catalysis of the reaction takes place after an induction phase of about 20 minutes. Thus, the oleic acid contributes significantly to the acceleration of the reaction.

Finally, LMOA magnetic nanocapsules embedded in the matrix were measured (FIG. 6e), which also show no catalytic activity at 50° C., but catalyze the reaction at 120° C. after an induction phase of about 11 minutes. Compared to the pure, un-encapsulated magnetite, catalysis does not take place step by step, but suddenly, which again shows that the encapsulation method is very suitable for a thermolatent catalysis. The accelerating effect of the magnetic nanocapsules on the PU reaction seems to be mainly due to the oleic acid. However, the induction phase is 9 minutes shorter using LMOA capsules than in oleic acid catalysis. As expected, the oleic acid as a homogeneous catalyst should catalyze the reaction faster. The additional acceleration is thus most likely caused by the combination of magnetite and the organic acid, similar to the organotin catalyst Fomrez. However, the difference between molecular and particulate structures must always be taken into account, which makes direct comparability difficult.

FIG. 1 shows the morphology of the magnetic nanocapsules containing 10 wt.-% Magnetite prepared via a mini-emulsion in step (ii) of the process as described herein at various resolutions.

FIG. 2 shows the morphology of magnetic nanocapsules containing the catalyst Fomrez with 15 wt.-% and 46 wt.-% magnetite (FIG. 2a), 2b), 2c)) or 64% wt.-%, respectively, of magnetite (FIG. 2d), 2e), 2f)).

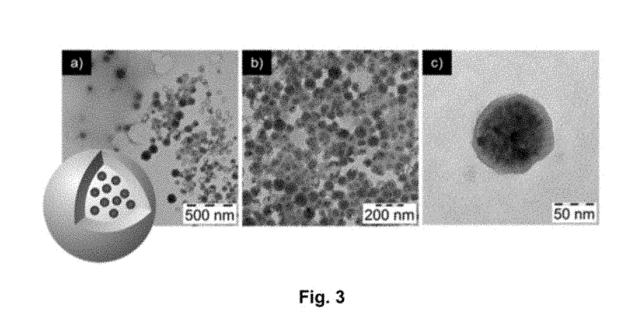

FIG. 3 shows the morphology of the magnetic nanocapsules containing 58 wt.-% Magnetite (LMOA) at different resolutions.

FIG. 4 shows the time-dependent measurement of complex viscosity matrix-forming monomers at a) 50° C. and b) 120° C. of nanocapsules without magnetic nanoparticles (FIG. 4c); TLCN 1), magnetic nanocapsules containing 54 wt.-% of magnetite and the catalyst Fomrez (FIG. 4d), LMOA F), and magnetic nanocapsules containing 64 wt.-% of magnetite and the catalyst Fomrez (FIG. 4e), HMOA F).

FIG. 5 shows a VSM measurement of magnetic nanoparticles containing 58 wt.-% of magnetite (LMOA).

FIG. 6 shows the time-dependent measurement of the complex viscosity of matrix-forming monomers at 50° C. and 120° C. of a) the pure matrix (castor oil and IPDI trimer), b) the matrix and magnetite with oleic acid functionalization, c) the matrix and magnetite without oleic acid functionalization, d) the matrix and oleic acid, e) the matrix and LMOA.

1. A process for the preparation of nanocapsules containing magnetic nanoparticles, comprising:
(A) (i) emulsifying a first reaction mixture (a) into a continuous aqueous phase, which comprises at least one stabilizer, about 10.0 to 99.0 wt.-% of a monomer mixture, the monomer mixture comprising, based on the total weight of the monomer mixture:
(a1) 2.5 to 19.0 wt.-%, of at least one monoethylenically unsaturated C₃₋₅-carboxylic acid monomer;
(a2) 76.0 to 97.5 wt.-%, of at least one monoethylenically unsaturated C₃₋₅-carboxylic acid C₁₋₁₀-alkyl ester monomer; and
(a3) 0.0 to 5.0 wt.-%, of at least one monomer which carries at least two ethylenically unsaturated groups;
(ii) emulsifying a second reaction mixture (b) into a continuous aqueous phase, which comprises at least one stabilizer, wherein the second reaction mixture, based on the total weight of the second reaction mixture, comprises:
(b1) 1.0 to 80.0 wt.-%, magnetic nanoparticles whose surface is hydrophobized; and
(b2) optionally 0.0 to 70.0 wt.-% of at least one polymerization catalyst or initiator; and
(b3) optionally 0.0 to 89.0 wt.-% of at least one hydrophobic releasing agent; and
(b4) optionally 0.0 to 10.0 wt.-% of at least one ultrahydrophobic compound other than the release agent;
(iii) combining the first reaction mixture of step (i) and the second reaction mixture of step (ii); and
(iv) polymerizing the monomers; or
(B) (i) emulsifying a reaction mixture into a continuous aqueous phase, comprising at least one stabilizer, the reaction mixture comprising, based on the total weight of the reaction mixture:
(a) 10.0 to 99.0 wt.-% of a monomer mixture, which, based on the total weight of the monomer mixture, comprises:
(a1) 2.5 to 19.0 wt-% of at least one single ethylenic unsaturated C₃₋₅ carboxylic acid monomer;
(a2) 76.0 to 97.5 wt.-% of at least one monoethylenically unsaturated C₃₋₅-carboxylic acid C₁₋₁₀-alkyl ester monomer;
(a3) 0.0 to 5.0 wt.-% of at least one monomer which carries at least two ethylenically unsaturated groups, preferably a divinylbenzene or a di- or triester of a C₂-C₁₀ polyol with ethylenically unsaturated C₃-C₅-carboxylic acids, in particular a di- or triester of a C₂-C₁₀-alkanediol or -triol with ethylenically unsaturated C₃-C₅-carboxylic acids,
(b) 1.0 to 70.0 wt.-% of magnetic nanoparticles; and
(c) optionally from 0.0 to 70.0 wt.-% of at least one polymerization catalyst or initiator; and
(d) optionally, 0.0 to 89.0 wt.-% of at least one hydrophobic releasing agent; and
(e) optionally, from 0.0% to 10.0 wt.-% of at least one ultrahydrophobic compound other than the release agent;
(ii) optionally homogenizing the emulsion of step (i); and
(iii) polymerizing the monomers.

2. The process according to claim 1, wherein the magnetic nanoparticles consist essentially of at least one magnetic metal or a magnetic derivative thereof selected from the group consisting of Sc, V, Cr, Fe, Co, Ni, Y, Zr, Mo, Ru, Mn, Pd, La, Ce, Pr, Nd, Gd, Tb, Dy, Ho, Er, Tm, Lu, Ta, Os, Ir, Pt, Au, Th, Eu, Sm, Yb, Al, U or a combination thereof.

3. The process according to claim 1, wherein the magnetic nanoparticles, the average size of the magnetic nanoparticles is in the range of <50 nm.

4. The process according to claim 1, wherein the surface of the magnetic nanoparticles is hydrophobized with at least one ligand, wherein the ligand
(a) has a Hansen parameter δₜ of less than 20.

5. The process according to claim 1, wherein the monomers for the capsule shell are selected such that the copolymer obtainable from the monomer mixture has a theoretical glass transition temperature T_{g} of 95° C. or more, calculated analogously to the Fox equation.

6. The process according to claim 1, wherein the average size of the nanocapsules is in the range of 50 to 500 nm.

7. The process according to claim 1, wherein the at least one polymerization catalyst or initiator
(a) has a Hansen parameter δₜ of less than 20 MPa^{1/2}.

8. The process according to claim 1, wherein the hydrophobic release agent
(a) has a Hansen parameter δₜ of less than 19 MPa^{1/2}.

9. The process according to claim 1, wherein the Hansen parameter δ_{d} of the polymer of the capsule shell is 15-19 MPa^{1/2}, the Hansen parameter δ_{P} is 10-14 MPa^{1/2}, the Hansen parameter δₕ is 13-17 MPa¹¹², and the Hansen parameter δₜ is 23-28 MPa^{1/2}.

10. The process according to claim 9, wherein the compound or mixture to be encapsulated and the polymer of the capsule shell satisfy the relationship:
Rₐ/R₀>1, wherein
(Rₐ)²=4(δ_{dS}−δ_{dP})²+(δ_{pS}−δ_{pP})²+(δ_{hS}−δ_{hP})²,
S stands for the compound or compound mixture to be encapsulated and P for the polymer of the capsule shell, wherein R₀ is 8-15 MPa^{1/2}.

11. The process according to claim 1, wherein
(1) the at least one monoethylenically unsaturated C₃-C₅-carboxylic acid monomer is selected from methacrylic acid (MAA), acrylic acid (AA), fumaric acid, methylmaleic acid, maleic acid, itaconic acid or mixtures of two or more thereof; and/or
(2) the at least one monoethylenically unsaturated C₃₋₅ carboxylic acid —C₁₋₁₀-alkyl ester monomer is an acrylic acid or methacrylic acid alkyl ester or mixtures thereof; and/or
(3) the at least one ethylenically unsaturated C₃₋₅-carboxylic acid C₁₋₁₀-alkyl ester monomer is a methacrylic acid C₁-C₅-alkyl ester monomer.

12. A composition containing the nanocapsules created by the process according to claim 1, and a polymerizable resin, preferably at least one polyisocyanate or NCO-functional prepolymer and at least one compound having at least two NCO-reactive groups.

13. The composition according to claim 12, wherein the composition is an adhesive, sealant, infusion resin or coating agent.
